(19) United States
(12) Patent Application Publication
(10) Pub. No.: US 2008/0311536 A1
(43) Pub. Date: Dec. 18, 2008

(54) Dental Impression Trays

(76) Inventors: Ki-suk Kim, Chungcheongnam-do (KR); Jun-Hee Lee, Chungcheongnam-do (KR)

Correspondence Address: JORDAN AND HAMBURG LLP, 122 EAST 42ND STREET, SUITE 4000, NEW YORK, NY, 10168, US

(21) Appl. No.: 11/658,545

(22) PCT Filed: May 25, 2005
(86) PCT No.: PCT/KR05/01542

§ 371 Date: Jan. 24, 2007

(30) Foreign Application Priority Data
Sep. 1, 2004 (KR) 20-2004-0025064
Sep. 8, 2004 (KR) 10-2004-0071793

(51) Int. Cl. A61C 9/00

(52) U.S. Cl. 433/37

(57) ABSTRACT

Disclosed is a dental impression tray realized such that the width of the dental impression tray can be adjusted to match different sizes of patient's dental arches and the adjusted width of the dental impression tray can be stably maintained during the procedure of obtaining an impression of teeth of a patient. The dental impression tray includes first and second container parts to contain an impression material therein, the container parts being shaped to correspond to a patient's dental arch and being separated from each other; a pivot part to pivot the first and second container parts together such that the container parts can be rotated around the pivot part, thus adjusting the width between the container parts; and a handle part extending from the container parts and being gripped and handled by an operator while adjusting the width between the container parts, and being provided with a locking means for stably locking the first and second container parts in positions corresponding to an adjusted width. Thus, the present invention can adjust the width of the dental impression tray to match sizes of patient's dental arches which are different from each other by the dental cavity and teeth of a patient, so that the tray can be adapted to all of the patients. Furthermore, the adjusted width of the tray can be stably maintained during the procedure of obtaining an impression of teeth of a patient, so that a correct dental impression can be quickly obtained.

### BACKGROUND OF THE INVENTION

1. Technical Field

The present invention relates, in general, to dental impression trays and, more particularly, to a dental impression tray which is realized such that the width of the dental impression tray can be adjusted to match different sizes of patient's dental arches and the adjusted width of the dental impression tray can be stably maintained during the procedure of obtaining an impression of teeth of a patient.

2. Background Art

Dental impression trays are dental instruments that are used for obtaining impressions of teeth of a patient using impression materials when it is required to make a dental model by copying the shape of a patient's oral cavity so as to examine and treat a defect or damage to teeth of the patient.

To obtain a correct impression of patient's teeth, it is required to select a correct dental impression tray after determining the horseshoe-shaped dental arch of the selected dental impression tray, which comprises the teeth and alveolar bone, such that the dental arch of the selected tray corresponds to that of a patient.

In the related art, a set of ready-made dental impression trays comprising four maxillary trays, which consist of small-sized, middle-sized, large-sized, and extra large-sized maxillary trays and three mandibular trays, which consist of small-sized, middle-sized, and large-sized mandibular trays have been used for obtaining dental impressions of teeth of patients having different dental arches.

However, to obtain a dental model of teeth of a patient having a size that is smaller or larger than the sizes of the ready-made dental impression tray set, it is necessary to forcibly close or open a selected tray so as to adjust the size of the tray prior to making a dental model. Thus, the conventional ready-made dental impression tray set is inconvenient to use.

In an effort to overcome the above-mentioned problems, a dental impression tray, which is realized such that the width of the tray can be freely adjusted to obtain a desired impression of teeth of a patient, has been proposed as disclosed in Korean Utility Model Registration No. 220285 (Title of the Device: Variable dental impression tray set). This variable dental impression tray set is shown in FIG. 1 of the accompanying drawings.

As shown in FIG. 1, the conventional variable dental impression tray set comprises a mandibular tray 110 which is separated into two impression material container parts 111, each container part 111 being curved into a dental arch shape and having a U-shaped cross-section so that the container parts 111 can contain an impression material therein. A handle 112 extends from an end of each of the two container parts 111. The two handles 112 are pivoted together by a pivot member 113 so that the two handles 112 can be rotated around the pivot member 113. Thus, the width between the two container parts 111 can be adjusted, so that the width of the mandibular tray unit 110 is adjustable to match the size of the mandibular tray 110 to the size of a patient's dental arch. The conventional variable dental impression tray set further comprises a maxillary tray 120, the structure of which is very similar to that of the mandibular tray 110.

However, the pivot member 113 of each of the mandibular and maxillary trays 110 and 120 may fail to securely pivot the two handles 112 together. Therefore, when an impression of teeth of a patient is obtained using the two variable trays 110 and 120, the two container parts 111 of each tray 110, 120 may be rotated around the pivot member 113, thus causing a failure to make a correct dental model. Therefore, it is necessary to readjust the rotated container parts 111 to the correct shape, but the readjustment is very inconvenient to an operator. Furthermore, if the obtained impression of teeth of a patient does not correspond to the real dental arch of the patient, the dental model which was already produced according to the obtained impression must be discarded and a new model must be produced. This increases the time consumption and dental model production costs.

Most conventional dental impression trays, including the above-mentioned variable dental impression tray sets, are typically made of metals, so that the metal trays have high mechanical strengths. But, the metal trays force the owners of the trays to pay excessive money because the owners must purchase many trays which are classified by size into large-sized, middle-sized and small-sized trays. Furthermore, to repeatedly use the dental impression trays, the trays must be sterilized and disinfected repeatedly. However, because the sterilization and disinfection of the metal trays must be executed for a lengthy period of time, some operators of the trays may quickly sterilize the trays, thus making the trays unhealthy and unsanitary.

Particularly, to determine the size of a correct dental impression tray corresponding to the real dental arch of a patient, the operator may place seven trays, which are the four maxillary trays and the three mandibular trays, in the mouth of the patient one by one so as to find a tray that agrees with the size of the dental arch of the patient. Thus, the trays are inevitably contaminated with saliva of the patient during the procedure of determination of the dental arch size of the patient, so that, even if all of the trays are sterilized and disinfected after being used in the determination of the dental arch size of the patient, the work to obtain the impression of teeth of a subsequent patient may be executed under unhealthy conditions.

Furthermore, to reuse the dental impression tray which has been used to obtain an impression of teeth of a patient, the impression material must be removed from the tray and the empty tray must be sterilized. However, it is difficult to completely remove the impression material from the dental impression tray, so that the tray may be reused with remnants of the previously used impression material stuck to the tray, thus creating unsanitary and unhealthy conditions.

### BRIEF SUMMARY OF THE INVENTION

### Technical Problem

Accordingly, the present invention has been made keeping in mind the above problems occurring in the prior art, and an object of the present invention is to provide a dental impression tray, which is realized such that the width of the dental impression tray can be adjusted to match different sizes of patient's dental arches and the adjusted width of the dental impression tray can be stably maintained during the procedure of obtaining an impression of teeth of a patient.

Another object of the present invention is to provide a dental impression tray, which is manufactured as a disposable tray using an inexpensive synthetic resin material, so that the dental impression tray can be used under healthy conditions, and which is provided with implant holes so as to be used in an implanting operation.

### Technical Solution

In order to accomplish the above-mentioned objects, the present invention provides a dental impression tray comprising: first and second container parts to contain an impression material therein, the first and second container parts being shaped to correspond to a patient's dental arch and being separated from each other; a pivot part to pivot predetermined portions of the first and second container parts together such that the first and second container parts can be rotated around the pivot part, thus adjusting a width between the first and second container parts; and a handle part extending from predetermined portions of the first and second container parts and being gripped and handled by an operator while adjusting the width between the first and second container parts, and being provided with locking means for stably locking the first and second container parts in positions corresponding to an adjusted width.

The handle part according to the present invention may comprise a first handle extending from a predetermined portion of the first container part; and a second handle extending from a predetermined portion of the second container part, with an extension which extends from the second handle towards the first handle and partially overlaps with the first handle.

The locking means of the present invention may comprise: a threaded longitudinal hole formed on the first handle; and a locking protrusion formed on the extension of the second handle and inserted into and locked to the longitudinal hole.

The present invention may further comprise: an engaging part extending inwards from each of the first and second container parts so that the engaging parts of the container parts clasp each other while overlapping; or a lug formed on an exterior of each of the first and second container parts.

The present invention may further comprise: an extension part having a shape corresponding to each of the first and second container parts and locked to an end of each of the first and second container parts, thus extending outwards from the end of each of the container parts.

The present invention may further comprise: an extension part integrally formed on an end of each of the first and second container parts, with a cutting line formed along the junction between the extension part and the container part. Furthermore, the present invention may further comprise: a plurality of implant holes formed on the first and second container parts, with a cutting part formed around each of the implant holes so that a size of each of the implant holes can be enlarged.

The present invention may further comprise: a rib protrusion longitudinally formed along an outer circumferential surface of a rim of each of the first and second container parts. Furthermore, the present invention may further comprise: an engaging part provided on a predetermined portion of each of the first and second container parts so that the engaging parts of the first and second container parts interlock and overlap with each other.

Furthermore, the present invention may further comprise: a rib protrusion longitudinally formed along the outer surface of each of the engaging parts.

### ADVANTAGEOUS EFFECTS

The present invention can adjust the width of the dental impression tray to match the sizes of patient's dental arches which are different from each other by the dental cavity and teeth of a patient, so that the tray can be adapted to all of the patients. Furthermore, the adjusted width of the tray can be stably maintained during the procedure of obtaining an impression of teeth of a patient, so that a correct dental impression can be quickly obtained.

Furthermore, the dental impression tray of the present invention is manufactured as a disposable tray using an inexpensive synthetic resin material. Thus, this dental impression tray can be discarded without requiring sterilization and disinfection after being used, thereby being convenient to the operators and allowing the operators to execute dental operations under healthy conditions. Furthermore, the tray has implant holes, thus being efficiently used during an implanting operation. Therefore, this dental impression tray can be used as a multipurpose impression tray.

### BRIEF DESCRIPTION OF THE DRAWINGS

Accompanying the specification are figures which assist in illustrating the embodiments of the invention, in which:

FIG. 1 is an exploded perspective view illustrating the maxillary and mandibular impression trays of a conventional dental impression tray set proposed in the related art;

FIG. 2 is an exploded perspective view illustrating a maxillary impression tray according to an embodiment of the present invention;

FIG. 3 is a perspective view illustrating the assembled maxillary impression tray of FIG. 2;

FIGS. 4 and 5 are perspective views illustrating the operation of the maxillary impression tray of FIG. 3;

FIG. 6 is an exploded perspective view illustrating a maxillary impression tray according to another embodiment of the present invention;

FIG. 7 is a perspective view illustrating the assembled maxillary impression tray of FIG. 6;

FIG. 8 is an exploded perspective view illustrating a maxillary impression tray according to a further embodiment of the present invention;

FIG. 9 is a perspective view illustrating the assembled maxillary impression tray of FIG. 8;

FIG. 10 is a perspective view illustrating an assembled maxillary impression tray according to yet another embodiment of the present invention; and

FIG. 11 is a perspective view illustrating an assembled mandibular impression tray according to still another embodiment of the present invention.

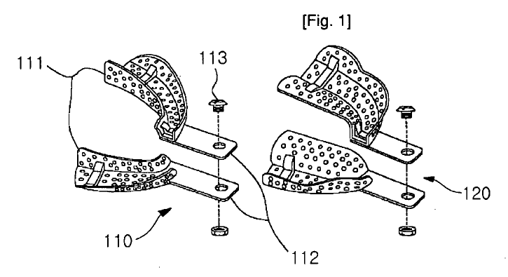

### DETAILED DESCRIPTION OF THE INVENTION

Herein below, dental impression trays according to preferred embodiments of the present invention will be described in detail with reference to the accompanying drawings.

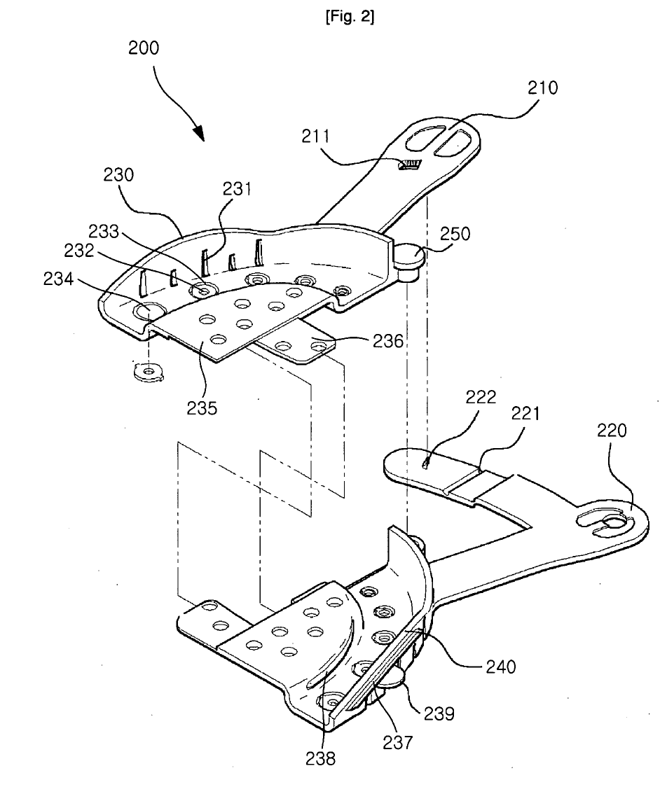

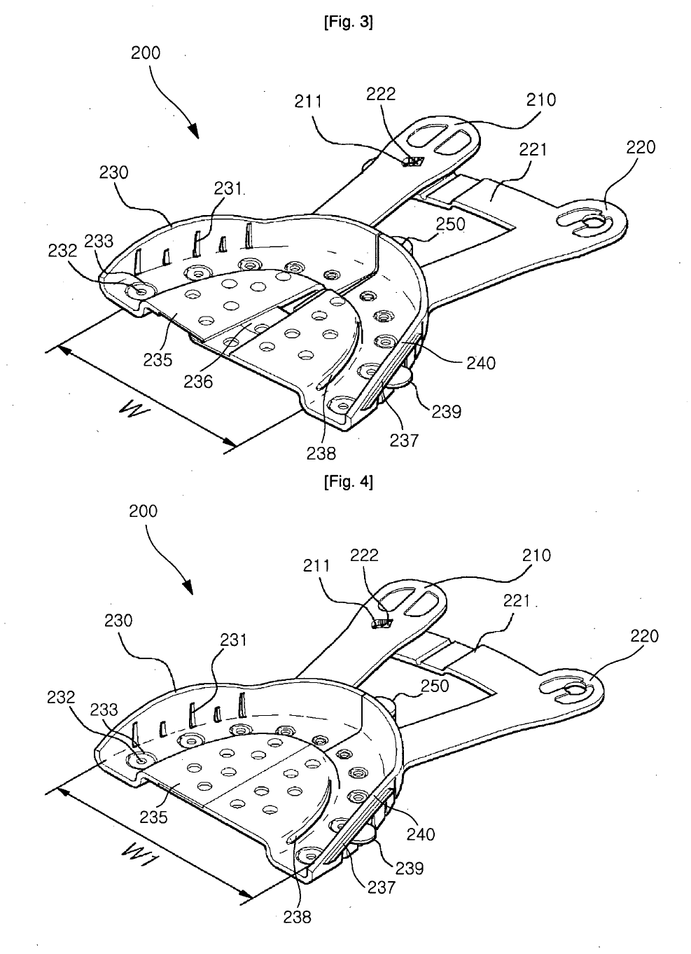

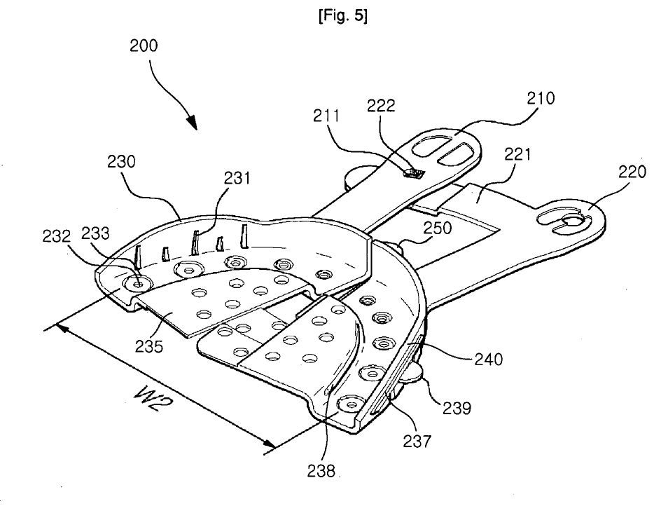

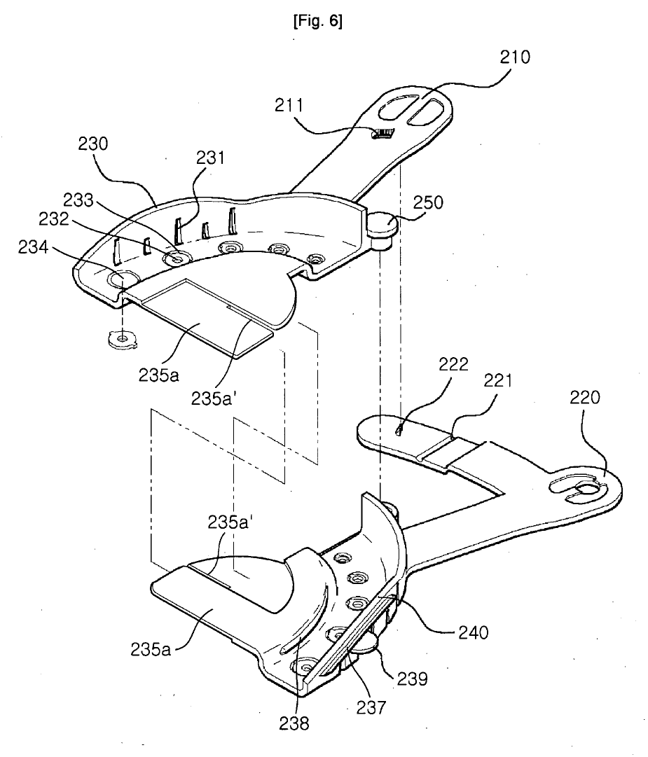

FIG. 2 is an exploded perspective view illustrating a maxillary impression tray according to a first embodiment of the present invention. FIG. 3 is a perspective view illustrating the assembled maxillary impression tray of FIG. 2. FIGS. 4 and 5 are perspective views illustrating the operation of the maxillary impression tray of FIG. 3.

As shown in FIGS. 2 through 5, the dental impression tray 200 according to the first embodiment of the present invention comprises first and second handles 210 and 220 to be gripped and handled by an operator, first and second impression material container parts 230 and 240 to contain an impression material therein, and a pivot part 250 to pivot the two container parts 230 and 240 together so that the two container parts 230 and 240 can be rotated around the pivot part 250 by manipulating the handles 210 and 220.

The first and second impression material container parts 230 and 240 are separated from each other, and the first container part 230 is integrated with the first handle 210 while the second container part 240 is integrated with the second handle 210. The pivot part 250 is an element that pivots the ends of the first and second impression container parts 230 and 240 together so that the width (W) between the two container parts 230 and 240 can be increased or reduced. The pivot part 250 comprises two parts, which are respectively and integrally formed on predetermined portions of the first and second container parts 230 and 240, and are pivoted together. In the present invention, either of the two parts of the pivot part 250 is preferably provided with a deformable hook on a predetermined end thereof so that the two parts of the pivot part 250 are easily pivoted together, but are not likely to be separated from each other once they are pivoted together.

The first handle 210 is provided with a threaded longitudinal hole 211, while the second handle 220 is provided with an extension 221 which extends towards the first handle 210 and partially overlaps with the first handle 210. A locking protrusion 222 is formed on a predetermined portion of the extension 221, such that the protrusion 222 is locked to the longitudinal hole 211 and locks the first and second handles 210 and 220 at adjusted positions. In the above case, the locking protrusion 222 engages with the threaded longitudinal hole 211, thus stably locking the first and second container parts 230 and 240 at the adjusted positions. The locking protrusion 222 has a size equal to or larger than that of the longitudinal hole 211 so that the protrusion 222 is forcibly fitted into the threaded hole 211.

Furthermore, as a modification of the first embodiment, a threaded longitudinal hole may be formed on the extension 221 of the second handle 220, while a locking protrusion may be formed on a predetermined portion of the first handle 210 such that the protrusion is fitted into the threaded hole. In this embodiment, both the threaded longitudinal hole and the locking protrusion to be locked to the threaded hole act as a locking means for securely locking the first and second impression material container parts 230 and 240 together. Thus, the locking means of the first embodiment may be embodied as a combination of a threaded longitudinal hole and a locking protrusion having a thread corresponding to the thread of the threaded hole, or a combination of a longitudinal hole having inward protrusions and a locking protrusion having a predetermined shape to be securely locked to the longitudinal hole.

Particularly, all of the parts of the dental impression tray according to the first embodiment are preferably made of a synthetic resin material. Due to the elasticity of the synthetic resin material, it is possible to somewhat change the position of the locking protrusion 222 locked in the longitudinal hole 211. In other words, the size of the dental impression tray of this embodiment can be adjusted to match different sizes of patient's dental arches by rotating the pivoted first and second handles 210 and 220 and increasing or reducing the width (W) between the first and second container parts 230 and 240. Furthermore, because the dental impression tray of this embodiment is made of a synthetic resin material, the locking protrusion 222 is forcibly inserted into, and stably and securely locked to, the longitudinal hole 211. Thus, the adjusted size of the dental impression tray 200 is not undesirably changed during the procedure of obtaining an impression of teeth of a patient, resulting in a production of a correct dental model.

Furthermore, all of the parts of the dental impression tray according to the first embodiment are manufactured as a disposable tray using an inexpensive synthetic resin material, so that the dental impression tray can be used under healthy conditions unlike the conventional metal trays designed to be repeatedly used.

Each of the first and second impression material container parts 230 and 240 of this embodiment is shaped to have a U-shaped cross-section, so that the container parts 230 and 240 can contain therein an impression material, such as Alginate or silicone impression material which is used to make a dental model. The first and second container parts 230 and 240 are separated from each other to the left and the right. Furthermore, a plurality of impression material holding holes 231 is formed on the rim of each of the first and second container parts 230 and 240, thus holding the impression material in the container parts 230 and 240. In the first embodiment of the present invention, each of the impression material holding holes 231 is shaped as an upwardly tapered trapezoidal profile which has a narrower upper part and a wider lower part. However, it should be understood that the impression material holding holes 231 may be freely shaped as another profile, such as a circular profile.

A plurality of implant holes 232 is formed through the bottom surface of the first and second impression material container parts 230 and 240. If the dental impression tray having the implant holes 232 is used for a patient having teeth, the implant holes 232 function to hold the impression material, in the same manner as expected from the impression material holding holes 231. However, when the dental impression tray having the implant holes 232 is used for a patient missing a tooth, a cutting part 233, which is formed around an implant hole 232 corresponding to a toothless part of the patient's mouth as shown in FIG. 4, is pressed down by the operator to form a larger hole 234. Thus, it is possible to obtain an impression of teeth of a patient requiring an implanting operation. Described in detail, the impression of the teeth of a patient requiring an implanting operation can be obtained by passing a fixture mount for the implanting operation through the larger hole 234.

Furthermore, the first and second impression material container parts 230 and 240 have respective engaging parts 235 which extend inwards in the container parts 230 and 240 and clasp each other while partially overlapping, thus accomplishing secure engagement of the first and second container parts 230 and 240. The engaging parts 235 also function to prevent formation of a vertical gap between the first and second container parts 230 and 240 and to prevent undesired separation of the two container parts 230 and 240 from each other. The engaging parts 235 have respective engaging protrusions 236, which protrude inwards from the facing edges of the engaging parts 235, with respective engaging spaces being defined below the engaging parts 235 at positions corresponding to the clasping engaging protrusions 236 so that the engaging protrusions 236 are seated in the respective engaging spaces. Furthermore, the engaging parts 235 are designed such that, when the engaging parts 235 are brought into close contact with each other, the contact line of the engaging parts 235 form a straight line as shown in FIG. 4.

Furthermore, a first rib protrusion 237 is longitudinally formed along the outer circumferential surface of the rim of each of the first and second container parts 230 and 240. The first rib protrusion 237 is used to add impression material to the outer circumferential surface of the rim of the tray 200 during a procedure of obtaining an impression of teeth of a patient, or to change the shape of the circumference of the rim of the tray 200 according to the condition of a patient's dental cavity, allowing a dental technician to easily execute his or her work. Described in detail, the first rib protrusions 237 function to allow a modeling material, such as wax or modeling compound, to be easily attached to the first and second container parts 230 and 240. The first rib protrusion 237 also functions as an impression material fixing means to reliably fix an impression material on the outer circumferential surface of the rim of the tray 200 and, furthermore, functions to obtain a correct impression of the gap between the teeth and the cheek of a patient. Furthermore, a second rib protrusion 238 is longitudinally formed along an outer surface of each engaging part 235 in the same manner as that described for the first rib protrusions 237 formed on the outer circumferential surfaces of the first and second container parts 230 and 240. The second rib protrusions 238 execute the same functions as those of the first rib protrusions 237 formed on the outer circumferential surfaces of the first and second container parts 230 and 240.

Furthermore, a lug 239 is formed on the exterior of the rim of each of the first and second container parts 230 and 240. When an impression material has been hardened in a patient's dental cavity, the tray 200 may be firmly stuck to the patient's teeth by the hardened impression material, so that the tray 200 may not easily be removed from the dental cavity. In the above state, the operator inserts his or her finger into the patient's dental cavity and moves the lugs 239 so as to twist the tray 200, thus easily removing the tray 200 from the dental cavity.

In the first embodiment, the pivot part 250 functions to pivot the first and second container parts 230 and 240 together such that the separated first and second container parts 230 and 240 are rotated around the pivot part 250. Described in detail, when the first and second handles 210 and 220 are rotated in directions to be spread apart from each other, the width between the first and second container parts 230 and 240 becomes reduced to W1 as shown in FIG. 4, so that the tray 200 may be adapted to a patient having a narrow dental arch. When the first and second handles 210 and 220 are rotated in directions to be closed together, the width between the first and second container parts 230 and 240 increases to W2 as shown in FIG. 5, so that the tray 200 may be adapted to another patient having a wide dental arch.

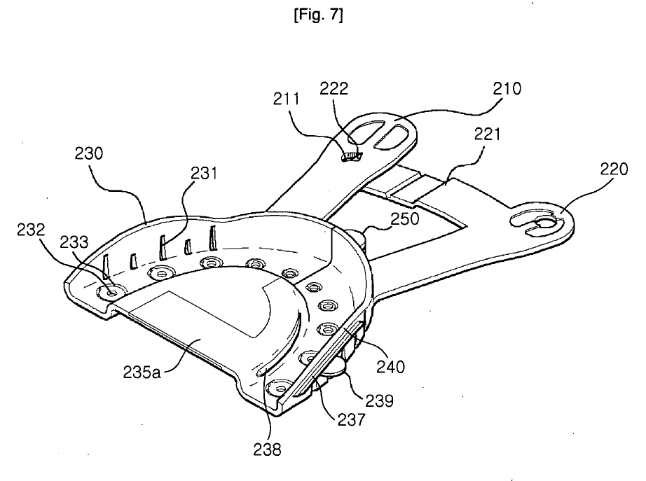

FIG. 6 is an exploded perspective view illustrating a maxillary impression tray according to a second embodiment of the present invention. FIG. 7 is a perspective view illustrating the assembled maxillary impression tray of FIG. 6.

As shown in FIGS. 6 and 7, the dental impression tray according to the second embodiment is constructed such that, although the width between the first and second impression material container parts 230 and 240 is adjusted and increased, the engaging parts 235a engage and overlap with each other over a maximum area, so that the first and second container parts 230 and 240 securely engage with each other. Described in detail, the two engaging parts 235a provided in the dental impression tray according to this embodiment have the same shape. However, the overlapping parts of the two engaging parts 235a, at which the two engaging parts 235a overlap with each other, are thinner than the other parts and have respective seats on the upper and lower surfaces thereof. The seats of the engaging parts 235a have profiles corresponding to the profiles of the engaging parts 235a. The two engaging parts 235a are provided with respective interlocking slits 235a′ along which the two engaging parts lock together. Therefore, in the dental impression tray according to this embodiment, the number of interlocking and overlapping parts between the two engaging parts 235a is increased so that the first and second container parts 230 and 240 securely lock together.

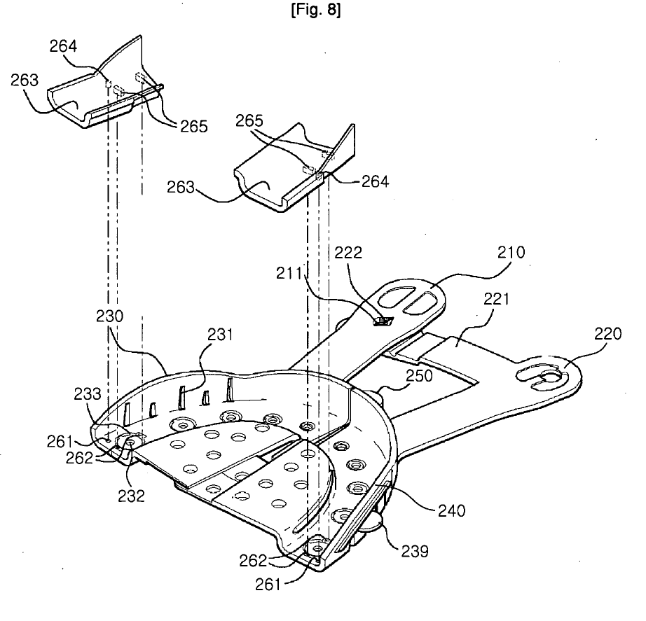

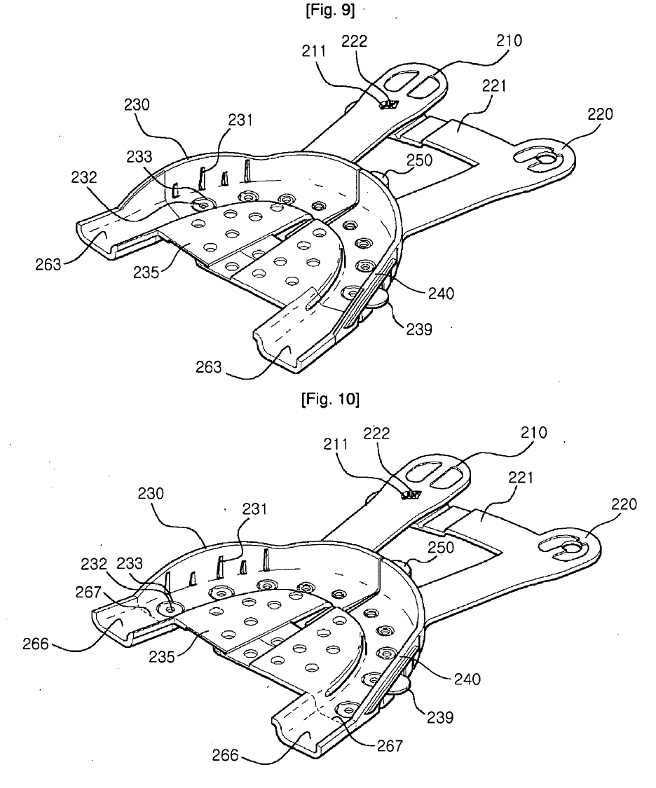

FIG. 8 is an exploded perspective view illustrating a maxillary impression tray according to a third embodiment of the present invention. FIG. 9 is a perspective view illustrating the assembled maxillary impression tray of FIG. 8.

As shown in FIGS. 8 and 9, the dental impression tray according to the third embodiment is constructed such that the tray can be particularly adapted to a patient having wisdom teeth or having an uncommonly big dental arch. Therefore, the general shape of the dental impression tray according to the third embodiment remains the same as that described for the embodiment shown in FIG. 3, but the size of the first and second impression material container parts 230 and 240 is increased. Described in detail, each of the first and second container parts 230 and 240 has both a first locking hole 261, which is formed around the end of each container part 230, 240, and a second locking hole 262 which is formed around an implant hole 232 provided at the end of each container part 230, 240. Two extension parts 263, each having first and second protrusions 264 and 265 on a lower surface thereof at positions corresponding to the first and second locking holes 261 and 262, are locked to the first and second locking holes 261 and 262. Thus, the first and second impression material container parts 230 and 240 extend outwards. In this embodiment, the extension parts 263 are configured to correspond to the first and second impression material container parts 230 and 240. Furthermore, to allow smooth engagement of the first and second impression material container parts 230 and 240, the overlapping parts of the two container parts are thinner than the other parts.

Furthermore, the extension parts 263 are made of the same synthetic resin material as are the first and second impression material container parts 230 and 240, so that the first and second protrusions 264 and 265 can be forcibly fitted into and fixed to the first and second locking holes 261 and 262, respectively. In the present invention, the extension parts 263 may be fixed to the first and second locking holes 261 and 262 through another method in addition to the above-mentioned method. Therefore, the dental impression tray according to this embodiment may be easily and simply assembled and may be normally adapted to a patient having wisdom teeth or having an uncommonly big dental arch.

FIG. 10 is a perspective view illustrating an assembled maxillary impression tray according to a fourth another embodiment of the present invention.

As shown in FIG. 10, the dental impression tray according to the fourth embodiment is constructed such that the tray can be selectively adapted to a normal patient having a normal dental arch and normal dentition without wisdom teeth or to another patient having wisdom teeth or an uncommonly big dental arch. Described in detail, the dental impression tray according to this embodiment is provided with two extension parts in the same manner as that described for the embodiment of FIG. 9. However, the extension parts 266 of this embodiment are integrally formed on respective ends of the first and second container parts 230 and 240, with cutting lines 267 formed along the junctions between the extension parts 266 and the container parts 230 and 240 such that the cutting lines 267 of the extension parts 266 are aligned with the edges of the engaging parts 235. Thus, when it is required to adapt the dental impression tray of this embodiment to a patient having wisdom teeth or an uncommonly big dental arch, the tray is used with the extension parts 266. However, when it is required to adapt the dental impression tray to another patient having a normal dental arch and normal dentition without wisdom teeth, the tray is used after the extension parts 266 have been cut from the tray along the cutting lines 267.

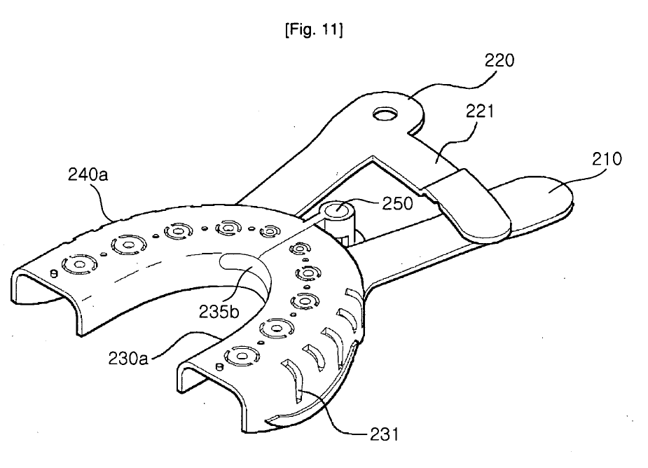

FIG. 11 is a perspective view illustrating an assembled mandibular impression tray according to a fifth embodiment of the present invention.

The present invention may be adapted to the maxillary impression trays as that described above and, furthermore, the invention may be adapted to the mandibular impression trays as shown in FIG. 11. Described in detail, the dental impression tray according to this embodiment is configured such that the concept of this dental impression tray remains the same as that described for the above-mentioned maxillary impression trays, but part of this impression tray is altered so as to accomplish secure engagement of the first and second impression material container parts 230a and 240a by removing maxillary elements of the engaging parts from the tray.

The dental impression tray according to this embodiment is constructed such that the first and second container parts 230a and 240a are deformed at close contact ends thereof, thus engaging and overlapping with each other at the deformed ends and forming the engaging parts 235b. Described in detail, the engaging parts 235b, at which the first and second container parts 230a and 240a interlock and overlap with each other, are thinner than the other parts of the container parts and have respective seats on the upper and lower surfaces thereof. Thus, in the dental impression tray according to this embodiment, the first and second container parts 230a and 240a securely lock together due to the engaging parts 235b which interlock and overlap with each other.

The present invention may be embodied in other specific forms without departing from its spirit or essential characteristics. The described embodiments are to be considered in all respects only as illustrative and not as restrictive. The scope of the invention is, therefore, indicated by the appended claims and their combination in whole or in part rather than by the foregoing description. All changes that come within the meaning and range of equivalency of the claims are to be embraced within their scope.

1.-10. (canceled)

11. A dental impression tray comprising:
first and second container parts to contain an impression material therein, the first and second container parts being shaped to correspond to a patient's dental arch and being separated from each other;
a pivot part to pivot predetermined portions of the first and second container parts together such that the first and second container parts can be rotated around the pivot part, thus adjusting a width between the first and second container parts;
a handle part including:
a first handle extending from a predetermined portion of the first container part, a second handle extending from a predetermined portion of the second container part, with an extension which extends from the second handle towards the first handle and partially overlaps with the first handle, and a locking means including a threaded longitudinal hole formed on the first handle; and
a locking protrusion formed on the extension of the second handle and inserted into and locked to the longitudinal hole, and adjusting the width between the first and second container parts while the first and second handle being gripped by an operator and stably locking the first and second container parts in positions corresponding to an adjusted width; and
an engaging part extending inwards from each of the first and second container parts so that the engaging parts clasp each other while overlapping to prevent formation of a vertical gap between the first and second container parts.

12. The dental impression tray of claim 11, farther comprising:
a lug formed on an exterior of each of the first and second container parts.

13. The dental impression tray according to claim 11, further comprising:
an extension part having a shape corresponding to each of the first and second container parts and locked to an end of each of the first and second container parts, thus extending outwards from the end of each of the container parts.

14. The dental impression tray of claim 11, further comprising:
an extension part integrally formed on an end of each of the first and second container parts, with a cutting line formed along a junction between the extension part and the container part.

15. The dental impression tray of claim 11, further comprising:
a plurality of implant holes formed on the first and second container parts, with a cutting part formed around each of the implant holes so that a size of each of the implant holes can be enlarged.

16. The dental impression tray of claim 11, further comprising:
a rib protrusion longitudinally formed along an outer circumferential surface of a rim of each of the first and second container parts.

17. The dental impression tray of claim 11, further comprising:
an engaging part provided on a predetermined portion of each of the first and second container parts so that the engaging parts of the first and second container parts interlock and overlap with each other.

18. The dental impression tray of claim 11, further comprising:
a rib protrusion longitudinally formed along an outer surface of each of the engaging parts.
